(19) United States
(12) Patent Application Publication
(10) Pub. No.: US 2026/0273538 A1
(43) Pub. Date: Sep. 17, 2026

(54) Cone crusher with skewed axis

(71) Applicant: FLSmidth A/S, Valby (DK)

(72) Inventors: Viktor Raaz, Bochum (DE); Tomasz Kwiatkowski, Essen (DE)

(21) Appl. No.: 19/166,025

(22) PCT Filed: Mar. 18, 2024
(86) PCT No.: PCT/IB2024/052595

§ 371 Date: Sep. 16, 2025

(30) Foreign Application Priority Data
Mar. 17, 2023 (DE) 10 2023 106 730.3
Mar. 17, 2023 (LU) LU503670

(51) Int. Cl. B02C 2/04

(52) U.S. Cl. CPC B02C 2/04

(57) ABSTRACT

The invention relates to a cone crusher (1) for comminuting lumpy feed material (material to be crushed), with a crushing cone (6) supported on an axial bearing, inclined to the axis of rotation (R) and driven by an eccentric bushing (12), wherein the eccentric bushing (12) rotates in radial guidance around a fixed axle journal (10). The invention is characterized in that a central axis (Z) of the crushing cone (6) is aligned skewed to the axis of rotation (R) of the eccentric bushing (12). The invention further relates to an eccentric bushing (12) and a method.

The invention relates to a cone crusher for comminuting lumpy feed material (material to be crushed), with a crushing cone supported on an axial bearing, inclined to the axis of rotation and driven by an eccentric bushing, wherein the eccentric bushing rotates in radial guidance around a fixed axle journal. The invention further relates to an eccentric bushing for use with such a cone crusher, as well as a method for comminuting lumpy feed material (material to be crushed) using the cone crusher.

Crushers are mechanical comminution systems for crushing lumpy feed material (material to be crushed), whereby the particle shape and the average particle size of the feed material are mechanically reduced during the crushing process, so that a targeted influence on its particle size distribution is exerted. Using crushers, agglomerates, composites and other composite structures in particular can also be broken down in the feed material in order to expose their subunits or components. The feed material is typically a mineral raw material with particle sizes in the coarse to medium size range. For example, crushers are used industrially in mining operations to process coal, ores, salts or other minerals, in quarries and gravel works to extract sand, gravel, chippings and pebbles with the desired properties, and in industrial operations to comminute the raw materials used, such as lime works and coal-fired power plants or chemical companies (in the latter also for the processing of products), in cement works for the processing of cement or in the construction industry for the processing of building rubble, for which these crushers can be designed stationary or mobile. Crushers naturally offer many advantages when feed material that exhibits brittle fracture behavior is to be comminuted.

For the continuous coarse comminution and pre-comminution of brittle, medium-hard and hard feed material, cone crushers and gyratory crushers are utilized, among other things, in which pressure comminution and/or impact comminution is carried out, in which the feed material is subjected to high mechanical stress. This type of crusher has a crushing chamber which is at least substantially formed by a hollow cone-shaped housing and a crushing cone. The hollow cone-shaped housing is at least partially lined with a wear-resistant crusher jacket (crushing ring). Accordingly, at least a part of the jacket surface of the crushing cone is also lined with a wear-resistant crushing cone jacket. The crusher jacket and crushing cone jacket are subject to high levels of wear due to the mechanical stress during the crushing process and are therefore designed to be replaceable as wear parts. The crushing cone is arranged as a movable cone-shaped crushing element on a crushing cone axle (also referred to as crushing axle, crushing cone shaft, or crushing cone pin) in the crushing chamber. The center line of the predominantly rotationally symmetrical crushing axle is deflected at a deflection angle to the crushing ring, which forms the hollow cone-shaped housing, wherein the intersection of the center line of the crushing axle and the crushing ring axle are in the upper region of the cone crusher. The crushing chamber is delimited at the bottom by an annular gap, which is formed by the lower region of the crushing cone jacket and the lower region of the crusher jacket and represents the discharge gap for the crushed material.

The lower end of the crushing cone axle projects into an eccentric bushing, so that the axis of rotation of the shaft that drives the eccentric does not coincide with the center axis of the crushing cone axle. During the crushing operation, the crushing cone axle—and thus also the crushing cone—is therefore set in a rotating wobbling motion. As a result, the annular gap does not have a constant gap width, but rather has a gap width that changes periodically along the circumference of the lower region of the crushing cone jacket during operation. During the wobbling motion of the crushing cone in the crushing chamber, the annular gap opens and closes all around, wherein the opening and closing occurs simultaneously on opposite sides of the crushing chamber. Typically, the gap width is changed by raising and lowering the crushing cone or the crushing ring.

Depending on the type of feed material and the characteristics of the crushed material to be achieved, different designs of crushing ring and crushing cone can be used, the characteristic size of which is the opening angle (cone angle) of the crushing cone: In a flat cone crusher, the crushing cone has a large opening angle (in particular opening angle between approximately 65° to approximately 100°), whereas the crushing cone of a steep cone crusher has a small opening angle (in particular opening angle between approximately 13° to approximately 45°). Steep cone crushers are typically used as primary crushers in order to subject feed material of large particle sizes with different particle shapes and sometimes a wide particle size distribution to a pre-comminution. The cones of steep cone crushers are operated at rather low rotational speeds, so that the chunks of material fed into the crushing chamber predominantly migrate downwards and are thereby comminuted by the periodically changing pressure acting on them (principle of pressure comminution). Flat cone crushers, on the other hand, are used as secondary crushers to comminute feed material of medium or small particle size with at least substantially similar particle shape; secondary crushers are often arranged behind primary crushers in the material flow path. Flat cone crushers are operated at rather higher rotational speeds; in addition to the periodically changing pressure stress, a further, pulse-like stress occurs, through which the feed material is comminuted (principle of impact comminution).

If a cone crusher is used as a coarse crusher, both crushing surfaces-the outside of the crushing cone jacket and the inside of the crusher jacket-often run in a straight line, so that they have the geometric shape of a truncated cone. However, if the crusher is used as a fine crusher, the crushing surfaces can also be curved concave/convex. In addition, the surfaces of the crushing cone jacket and/or crusher jacket can also have a rib structure.

Basically, gyratory crushers and cone crushers have a similar structure. In a gyratory crusher, the crushing cone axle is mounted in the upper part of the crusher (in the region of the intersection of the crushing cone center line and crushing ring axle) in a spherical bearing as a head bearing, which is arranged on a crossbar. With this arrangement, the crushing cone axle transfers the horizontal crushing forces into the crusher housing both via a bearing at the lower end and via the head bearing. Gyratory crushers can be used as steep cone crushers or as flat cone crushers. In contrast, in the case of a cone crusher, the upper end of the crushing cone axle can be overhung in the region of the axle crossing, so that there is no head bearing. With this arrangement, the crushing cone axle can only dissipate the horizontal crushing forces via a bearing at the lower end. Here, a short, particularly strong vertical axle journal absorbs all the forces and transfers them into the crusher housing. Cone crushers can be used as flat cone crushers. The vertical forces can also be dissipated via a spherical plain bearing socket, attached to the axle journal. The ball head support joint associated with the plain bearing socket is formed inside the crushing cone, the ball center point of which approximately coincides with the intersection of the axles.

Cone crushers typically have three regions, namely the lower section (which, among other things, contains the drive and the discharge device for the broken material), the middle section (which, among other things, contains the crushing chamber with the crushing cone and with at least part of the crusher jacket) and the upper section (which contains, among other things, the feeding device).

The crushing effect of a cone crusher is achieved by the rotating wobbling movement of the crushing cone in that the changing annular gap between the crushing cone jacket and the crusher jacket exerts pressure on the feed material so that it breaks up and is thus comminuted. The crushing cone jacket and crusher jacket are therefore exposed to particularly high mechanical stresses and must therefore be replaced from time to time, which is why they are detachably attached to the cone crusher. For this purpose, the crushing cone typically has a crushing cone body which is connected to the crushing cone axle in a rotationally fixed manner. On the outside of the crushing cone body lies the crushing cone jacket, which is typically bell-shaped as a hollow cone and has an opening in its upper section through which the crushing cone axle is guided. The crushing cone jacket is fixed to the crushing cone body, for which different attachment systems exist.

Various efforts have already been made to reduce wear on cone or gyratory crushers, for example through certain designs of the crushing cone jacket and/or crusher jacket or through certain materials. The maintenance of such a crusher is also a relevant topic on which a lot of research has been carried out.

For example, from EP 3 129 148 B1 a cone crusher is known in which the axle journal is braced in a certain way. From DE 10 2012 110 267 a gyratory crusher is known with a hydraulic tensioning device on the traverse. Furthermore, a special type of eccentric sleeve is known, for example from EP 3 132 853 A1, which enables a distributed mounting in order to achieve improved weight compensation in particular.

Another problem that exists in the field of cone and gyratory crushers is that the relative stroke in the upper region, i.e. the intake region of the crusher, is smaller and sometimes significantly smaller than in a lower region, i.e. the discharge region of the crusher. If one takes into account that a relative stroke of at least 10% is required for a high probability of breakage of 90% or more, the problem in many cases is that only a relatively low probability of breakage can be achieved in the intake region of the crusher. This can impair the efficiency of the crushing process, as there is still relatively large, unbroken material in the intake region, which prevents further material to be crushed from being conveyed.

An object of the invention is therefore to provide a cone crusher for comminuting lumpy feed material, which can achieve higher efficiency, allows a higher throughput and/or lower and/or more balanced wear.

The invention achieves the object with a cone crusher of the type mentioned at the outset, in that the central axis of the crushing cone is aligned skewed to the axis of rotation of the eccentric bushing (claim 1). While in conventional cone crushers the central axis of the crushing cone is simply not parallel to the axis of rotation, such that the central axis of the crushing cone and the axis of rotation of the eccentric bushing intersect at a point approximately in the region of the cone tip or above the cone tip, the invention provides that the central axis of the crushing cone is aligned skewed to the axis of rotation of the eccentric bushing. In other words, in addition to the inclination of the center line of the crushing cone axle (central axis of the crushing cone) known in the prior art, which leads to the eccentricity of the eccentric bushing, the invention provides an offset of the central axis of the crushing cone, preferably perpendicular to the plane of the inclination, so that the central axis of the crushing cone (crushing cone center line) and the axis of rotation of the eccentric bushing are skewed to one another and do not intersect.

The invention is based on the knowledge that the skewed alignment of the axles causes an axial offset between the two axles, which in turn leads to a higher relative stroke being achievable, particularly in the upper region of the crushing cone, which in turn can cause an increased probability of breakage. A higher probability of breakage can, in turn, lead to increased throughput and thus increased efficiency of the cone crusher. Maintenance can also be improved, as more uniform wear of the crushing elements can be expected due to the higher probability of breakage in the upper region of the cone crusher.

In a first preferred embodiment, a vertical distance between the central axis of the crushing cone and the axis of rotation of the eccentric bushing is 5% or more of the eccentricity of the eccentric bushing. The eccentricity of the eccentric bushing is the result of the axis inclination of the central axis of the crushing cone and therefore varies over the axial length of the eccentric bushing. The eccentricity of the eccentric bushing is determined as the average of the minimum and maximum deviation of the bushing central axis from the axis of rotation.

Preferably the distance is 10% or more, 20% or more or 50% or more. The distance is preferably simultaneously 30% or less, 50% or less, 70% or less.

In a preferred development it is provided that a phase shift between the closed gaps (GSS) in the upper and lower regions of the crushing chamber is at least 5°, preferably at least 15°, and particularly preferably at least 45°. The phase shift is caused by the skewed alignment of the central axis of the crushing cone to the axis of rotation. What is meant here by phase shift is that the position of the closed gap (GSS), i.e. the smallest distance between the crushing cone jacket and the crusher jacket in the upper region, and the closed gap (GSS), i.e. the smallest distance between the crushing cone jacket and the crusher jacket in the lower region, is not at the same rotational position around the axis of rotation, but has a (fixed) phase shift to one another. Preferably, the phase shift between the lower closed gap and the upper closed gap is at most 90°. If the point of a minimum distance between the central axis of the crushing cone and the axis of rotation is positioned below an upper end of the upper crushing chamber, the phase shift between the closed gap (GSS) in the upper and lower crushing chambers can also assume values above 90°, preferably a maximum of 180°.

The phase shift between the upper and lower closed gaps can result in increased throughput. This is due to the path of the material to be crushed through the crusher. Material to be crushed is typically crushed in the region of the closed gap, or just before it, since the largest relative stroke exists in the region of the closed gap and thus the greatest probability of breakage can be generated. Without a phase shift between the upper and lower closed gap, assuming vertical movement of the material to be crushed, it takes half a revolution of the eccentric bushing until the same material to be crushed is positioned again in the region of the closing gap. The fall time can be changed by a phase shift. For example, it can be provided that the upper closed gap is leading in the direction of rotation to the lower closed gap. In this way it can be provided that the material to be crushed, which moves vertically through the crusher, is first crushed in the region of the upper closed gap, then migrates vertically and radially down and is then crushed again immediately in the lower closed gap when the crushing cone continues to rotate. This means that the fall time for the material to be crushed is longer at the same speed, which means that the throughput can be significantly increased.

In a further preferred embodiment, the cone crusher comprises a head eccentric bushing which is axially spaced from the eccentric bushing along the axis of rotation and guides the crushing cone radially on the axle journal in the region of a minimum distance between the axis of rotation and the central axis of the crushing cone. In this way, a distributed mounting or a distributed eccentric bushing can be achieved, which enables improved support of the crushing cone on the axle journal. In addition, such a split eccentric bushing can advantageously be provided with a counterweight.

The cone crusher preferably also has a balancing weight, which is arranged with its center of mass shifted out of phase with the deflection plane of the central axis of the crushing cone. Preferably or alternatively, the center of mass of the balancing weight is arranged at least approximately, preferably exactly, diametrically opposite the resulting center of mass of the eccentric on the eccentric bushing. The balancing weight is preferably connected to the eccentric bushing or is part of it. In conventional cone crushers, the balancing weight, or counterweight, is typically exactly diametrically opposite to the center of mass of the eccentric relative to the axis of rotation, so that the unbalance of the eccentric can be compensated for by the balancing weight. Due to the inclined position of the crushing cone, the center of mass of the crushing cone in conventional cone crushers is also arranged exactly diametrically opposite to the balancing weight. This means that in conventional cone crushers, a center of mass of the balancing weight is exactly diametrically opposite in relation to the axis of rotation to the center of mass of the eccentric and the center of mass of the crushing cone. However, in the cone crusher according to the invention described herein, the balancing weight should be approximately opposite the resulting centers of mass from the eccentric and the crushing cone. The three centers of mass, the center of mass of the eccentric, the center of mass of the crushing cone and the center of mass of the balancing weight do not lie on a plane that also contains the axis of rotation, but rather span a plane that is intersected by the axis of rotation.

According to a further preferred embodiment, the central axis of the crushing cone is aligned with the axis of rotation of the eccentric bushing in such a way that a relative stroke of at least 3%, preferably at least 5%, can be carried out in an upper region of the crushing chamber. A relative stroke of 7% and more, 8% and more, 9% and more, 10% and more can preferably be carried out. In this way, the probability of breakage in the upper region of the crushing chamber is significantly increased.

In a preferred development it is provided that the crushing cone is floatingly mounted. A crushing cone with a floating bearing is typically referred to as a classic cone crusher. For axial support of the crushing cone, a spherical bearing surface is preferably provided under the crushing cone, which is axially mounted on a spherical bearing socket, which is further preferably displaceably mounted on the axle journal. In this way, preferred axial support of the crushing cone can be achieved. In the case of floating mounting, the crushing cone is therefore only guided and supported by the axial bearing, which is preferably spherical as described, and radially by the eccentric bushing.

In a preferred development, the cone crusher comprises a head support for the crushing cone, wherein the crushing cone is mounted on the head support in a freely rotating but preferably eccentric manner. The crushing cone preferably comprises a support ring via which the crushing cone is rotatably mounted on the head support. The head support is preferably arranged in the region of the minimum distance between the axis of rotation and the central axis of the crushing cone, since a particularly simple construction is made possible in this way. A cone crusher with such a head support is also referred to as a gyratory crusher, wherein the head support typically does not absorb any axial forces, but only offers radial support.

In order to compensate for the wobbling movement, the head support preferably comprises a first outer radial bearing and a second inner radial bearing, wherein the second inner radial bearing is mounted eccentrically radially within the first outer radial bearing and the crushing cone is mounted on the second inner radial bearing. An eccentric ring is preferably formed between the first and second radial bearings, which enables the second bearing to be mounted eccentrically in the first bearing. Preferably, the inner, second radial bearing further carries a support ring which is in contact with the crushing cone in order to radially support the crushing cone.

The angular positions of the eccentric bushing and the eccentric ring are advantageously synchronized with one another in order to avoid high restoring forces due to the tilting of the central axis of the crushing cone in the eccentric bushing. While when the crusher is idling, synchronization can occur solely through the reaction forces in the eccentric bushing, a deviation from the specified phase shift of the two eccentrics can cause bearing forces. In order to ensure synchronization during operation, the crusher preferably has a synchronization device. For example, the synchronization device can include a mechanical coupling between the eccentric bushing and the eccentric ring in order to maintain the phase position of the eccentric bushing and the eccentric ring. Alternatively or additionally, a kinematic connection can preferably be provided within the crushing cone, such as a shaft that is mounted centrally in an axial passage in the crusher cone or the crusher axis, and/or a drive unit for the eccentric ring, which preferably drives it depending on the phase position.

In a second aspect, the invention achieves the object mentioned at the outset by means of an eccentric bushing which is intended for use with a cone crusher according to any one of the preferred embodiments of a cone crusher described above according to the first aspect of the invention. According to the second aspect of the invention, the eccentric bushing preferably has a radially inner and a radially outer plain bearing, wherein the radially inner plain bearing is in contact with the axle journal and the radially outer plain bearing is in contact with a corresponding section of the crushing cone. The radially inner plain bearing and the radially outer plain bearing are preferably arranged skewed to one another. Each of the inner and outer plain bearings forms a cylinder jacket and the central axes of these cylinder jackets are skewed to one another.

In a further aspect, the invention achieves the object mentioned at the outset by a method for comminuting lumpy feed material by means of a cone crusher according to any one of the above-described preferred embodiments of a cone crusher according to the first aspect of the invention, wherein the crushing cone is driven so that an upper closed gap precedes a lower closed gap. Alternatively, it is provided that the crushing cone is driven in such a way that an upper closed gap follows a lower closed gap.

It should be understood that the cone crusher according to the first aspect of the invention, the eccentric bushing according to the second aspect of the invention and the method according to the third aspect of the invention have the same and similar sub-aspects as set out in particular in the dependent claims. In this respect, for preferred embodiments and further developments of the eccentric bushing according to the second aspect of the invention and the method according to the third aspect of the invention, reference is made in full to the above description of the first aspect of the invention.

Embodiments of the invention will now be described below with reference to the drawings. These are not necessarily intended to represent the embodiments to scale; rather, if this is useful for explanation, the drawings are executed in a schematic and/or slightly distorted form. With regard to additions to the teachings immediately apparent from the drawings, reference is made to the relevant prior art. It should be noted that various modifications and changes can be made to the form and detail of an embodiment without departing from the general idea of the invention. The features of the invention disclosed in the description, in the drawings and in the claims can be essential for the development of the invention both individually and in any combination. In addition, all combinations of at least two of the features disclosed in the description, the drawings and/or the claims fall within the scope of the invention. The general idea of the invention is not limited to the exact form or detail of the preferred embodiments shown and described hereinafter or limited to a subject matter that would be limited in comparison to the subject matter claimed in the claims. For specified design ranges, values within the specified limits should also be disclosed as limit values and can be used and claimed as desired. For the sake of simplicity, the same reference numerals are used below for identical or similar parts or parts with identical or similar functions.

Further advantages, features and details of the invention emerge from the following description of the preferred embodiments and from the drawings; in the following:

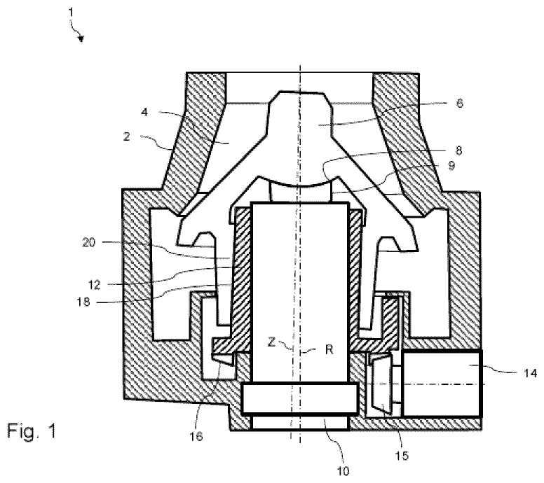

FIG. 1 shows a cross-section through a cone crusher according to the invention;

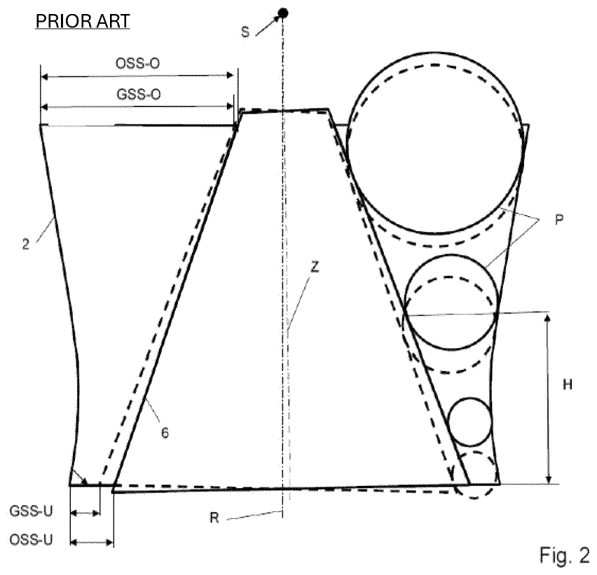

FIG. 2 shows a schematic view of a cone crusher according to the prior art;

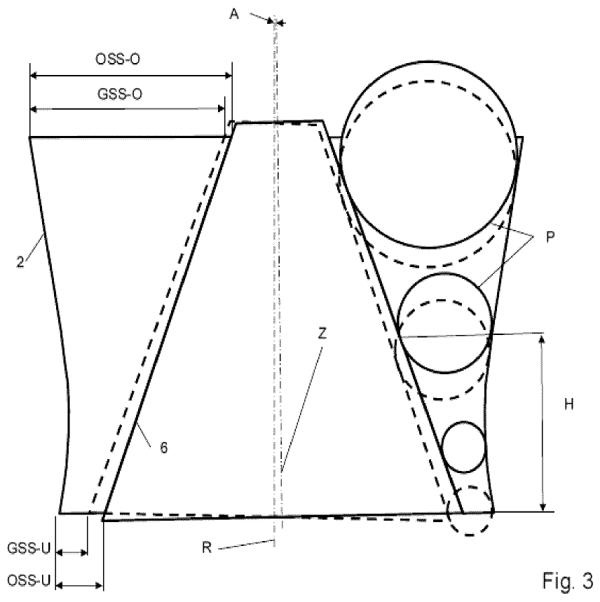

FIG. 3 shows a schematic view of a cone crusher according to the invention;

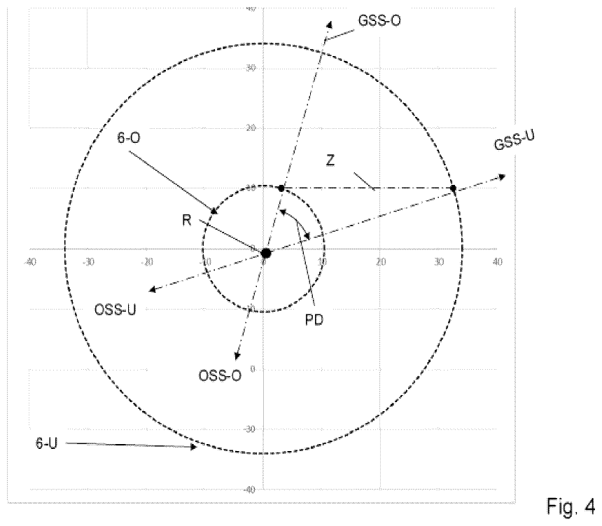

FIG. 4 shows a schematic top view of the crushing cone according to FIGS. 1 and 3;

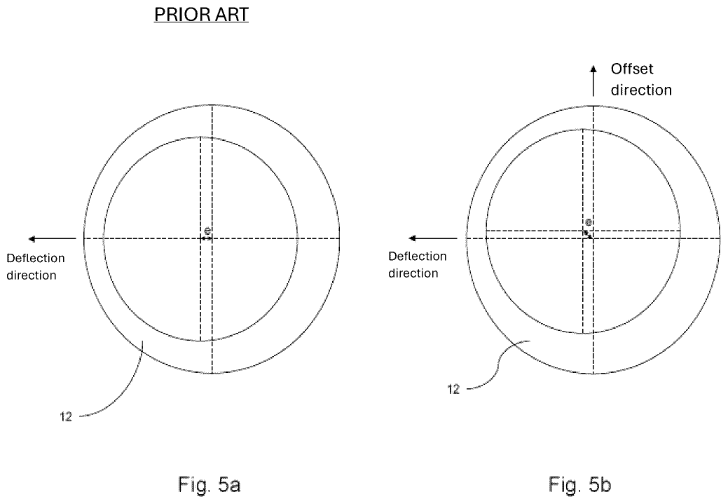

FIGS. 5a, 5b show schematic views of an eccentric bushing according to the prior art and according to the invention;

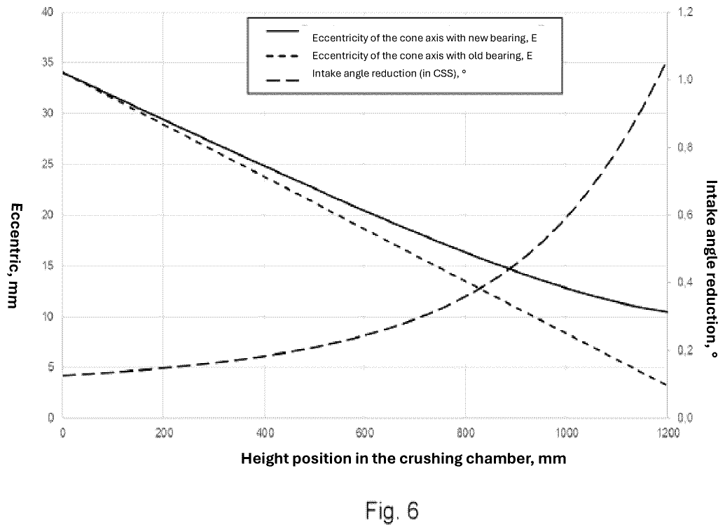

FIG. 6 shows a diagram showing eccentricity and intake angle reduction depending on the height position in the crushing chamber;

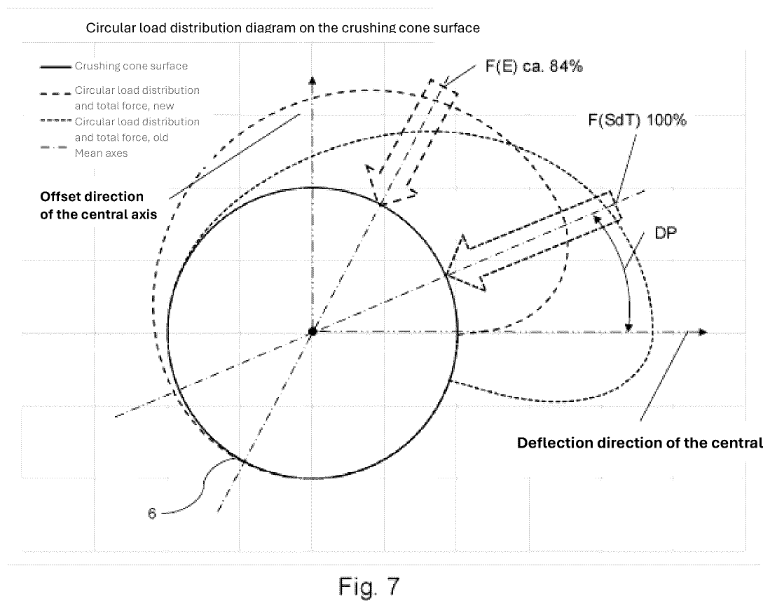

FIG. 7 a diagram illustrating the force effect on the axle journal of the cone crusher; and

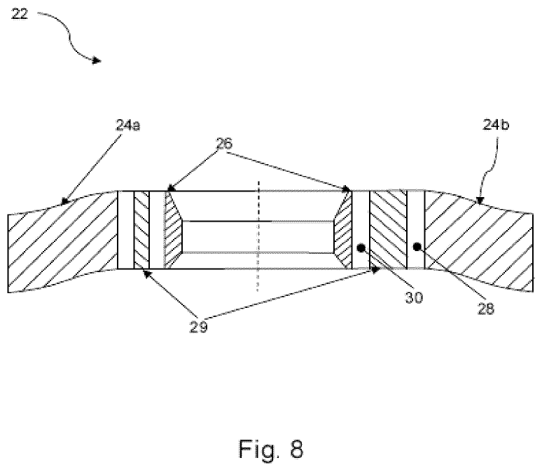

FIG. 8 shows a schematic representation of a traverse for a cone crusher designed as a gyratory crusher.

A cone crusher 1 is known in its basic structure in the prior art. It has a crusher housing 2, which defines a crushing chamber 4 inside. The crushing chamber 4 is formed between a crusher jacket, not shown here, on the radially inner region of the crusher housing (crushing ring) and a crushing cone jacket of the crushing cone 6, also not shown here. The crushing cone 6 has a spherical plain bearing 8, which rests against a spherical plain bearing socket 9. The spherical plain bearing socket 9 is supported and mounted in a horizontally displaceable manner on a fixed axle journal 10, which in turn is firmly and rigidly connected to the crusher housing 2. In this respect, the spherical plain bearing 8 and the spherical plain bearing socket 9 together form an axial bearing for the crushing cone 6.

The axle journal 10 also defines a plain bearing on its jacket surface, which interacts with a radially inner surface of an eccentric bushing 12 in a basically known manner. The axle journal 10 itself is vertically aligned and the jacket surface forms a cylindrical surface which is also vertically aligned. The central axis of the axle journal 10 forms the axis of rotation R, about which the eccentric bushing 12 can rotate. The eccentric bushing 12 is driven via a drive pin 14 driven by a drive motor, not shown, which interacts with a sprocket 16 at the axially lower end of the eccentric bushing 12 and drives it.

In the exemplary embodiment shown here, the radially outer jacket surface 18 of the eccentric bushing 12 is both inclined to the axis of rotation R, that is, the central axis, which is defined by the radially outer jacket surface 18, is inclined to the axis of rotation R, as well as offset from it and thus skewed. On the radially outer jacket surface 18 of the eccentric bushing 12 sits a crushing cone plain bearing 20, which is substantially cylindrical and is designed coaxially to a central axis of the crushing cone 6. The central axis Z of the crushing cone 6 is therefore skewed to the axis of rotation R.

FIGS. 2 and 3 now show schematically the difference between a conventional cone crusher according to the prior art (FIG. 2) and a cone crusher according to the invention (FIG. 3). According to FIGS. 2 and 3, the crushing cone 6 is shown once with a solid line in a position in which the closed gap is located at the lower edge of the crushing chamber (GSS-U) on the right side of FIGS. 2 and 3, and with a dashed line a position of the crushing cone 6 is shown in which the closed gap is located at the lower edge of the crushing chamber (GSS-U) on the left side of FIG. 2. In FIG. 2, an intersection S between the axis of rotation R and the central axis Z of the crushing cone is shown in the upper region or above the crushing cone 6, which comes about because in the prior art only an inclination of the eccentricity specified by the eccentric bushing 12 is provided, but no offset. The axis of rotation R and the central axis Z are not skewed to one another in the prior art, as shown in FIG. 2.

On the right side of FIG. 2, particles P are also shown, which are arranged at three different positions in the crushing chamber. The height H of the particles P in the closed gap GSS is shown by solid lines and the position of the particles P after the gap opening is shown by dashed lines, depending on the position of the crushing cone 6.

FIG. 3 now shows an arrangement of the crushing cone according to the invention, in which the axis of rotation R and the central axis Z are skewed to one another. As can easily be seen from a comparison of FIGS. 2 and 3, in particular is the relative stroke in the upper region of the crushing cone (the relative movement of the crushing cone 6 back and forth; seen by the distance between the solid and dashed lines). As a result, the height of the particles P is also different, particularly in the upper region. The higher relative stroke in the upper region of the crushing cone 6 leads to a higher probability of breakage, the different height H of the particles P also leads to a higher throughput and thus to a higher efficiency.

FIG. 4 now illustrates the jacket surface, which is described by the central axis Z of the crushing cone 6, in a schematic top view. An upper section (6-O) and a lower section (6-U) of the jacket surface are shown in FIG. 4 with 6-O and 6-U. The two concentric circles are the sum of points that the crushing cone describes in its upper and lower sections on its wobbling movement. R is again the axis of rotation and Z is the central axis of the crushing cone. The axis of rotation R is perpendicular to the drawing surface of FIG. 4, while the central axis Z of the crushing cone 6 is skewed. The directions of the closed gap in the upper region and the closed gap in the lower region are denoted by GSS-O and GSS-U, respectively, and the open gap in the lower region and the open gap in the upper region are correspondingly opposite with OSS-U and OSS-O. As can be seen from FIG. 4, the closed gap in the lower region GSS-U is positioned at approximately 15° to the deflection plane of the central axis Z, while the closed gap in the upper region GSS-O is positioned at approximately 75°. This results in a phase difference PD between the point of the lower closed gap GSS-U and the point of the upper closed gap GSS-O of 60°. Depending on the direction of rotation of the eccentric bushing 12, the lower closed gap GSS-U can precede or follow the upper closed gap GSS-O. In particular, following can be positive for achieving a high throughput.

FIGS. 5a and 5b now show schematically in a top view an eccentric bushing 12 according to the prior art (FIG. 5a) and an eccentric bushing 12 according to the invention (FIG. 5b). In the case of the eccentric bushing 12 according to the prior art (FIG. 5a), there is an eccentricity e in the cross-sectional area, which is caused by the tilting or deflection of the central axis Z of the crushing cone to the axis of rotation R.

With skewed mounting, the deflection of the central axis Z to the axis of rotation R is initially reduced; in addition, however, according to the invention (FIG. 5b), an offset of the central axis Z of the crushing cone 6 to the axis of rotation R is also implemented, which is perpendicular to the plane which is defined by the deflection or tilting of the central axis Z of the crushing cone 6 and the axis of rotation R known in the prior art. The offset direction is indicated with an arrow in FIG. 5b. This results in a resulting eccentricity, which in the cross-sectional area of FIGS. 5a and 5b can be approximately the same size, larger or even smaller than the eccentricity e in the prior art, but differs in that the central axis Z and the aixs of rotation R are skewed are to each other.

FIG. 6 shows an effect of the changed eccentricity and the skewed arrangement of the axis of rotation R and the central axis Z. The values are shown as an example using a cone crusher with a crushing chamber height of 1200 mm. The eccentricity, as known in the art, is represented by the narrow dashed line running from top left to bottom right. It changes linearly over the height of the crushing chamber, which, as described above, is due to the intersection point S of the axis of rotation R and central axis Z located above the crushing cone 6. The eccentricity, that is, the distance of the central axis Z to the axis of rotation R (central axis Z in FIG. 6 also referred to as the “cone axis”) depending on the height position in the crushing chamber, is indicated in the cone crusher 1 according to the invention by the solid line running from the top left to the bottom right. This means that the eccentricity in the upper region of the cone crusher does not approach zero and will not be zero either, since the axis of rotation R and the central axis Z are skewed and do not intersect. Rather, the eccentricity in the exemplary embodiment shown amounts to a value of approximately 10 mm, so that there is still a clear eccentricity in the upper region of the crushing chamber. In the example shown, the eccentricity in the intake region of the cone crusher is approximately 10 mm, whereas in the prior art it is approximately 3 to 4 mm. This makes it possible to achieve a significantly larger relative stroke, which also leads to a significantly increased probability of breakage in the intake region of the cone crusher. At the same time, the intake angle is also reduced, which is indicated by the longer dashed line.

FIG. 7 additionally shows a circular load diagram in which the load distribution over the crushing cone in one revolution is shown. The solid line shows the crushing cone 6 in a circle, the ordinate shows the offset direction of the central axis Z (cone axis) and the abscissa shows the deflection direction of the central axis Z (cone axis). The narrow dashed line shows the force distribution in conventional cone crushers, which have no offset between the axis of rotation and the central axis, while the longer dashed line shows the embodiment according to the invention with a skewed offset between the central axis and the axis of rotation. As can be seen from FIG. 7, due to the phase shift between the upper and lower closed gap, a significantly larger circumference of the crushing cone is loaded (approximately 240°), whereas in the case of crushing cones in the prior art, only approximately 180° can be loaded. This allows opposing forces to partially cancel each other out, making the circular load distribution on the crushing cone surface more favorable. The total force according to the prior art F(PA) assumed to be 100% can be reduced to a total force F(I) of approximately 84% in embodiments of the invention. In addition, the phase of the total force changes, which means that the balancing weight also has to be positioned differently than is known in the prior art.

Finally, FIG. 8 shows a traverse 22 with a first and second traverse arm 24a, 24b, which in turn are supported on the crusher housing 2 (not shown). The traverse arms 24a, 24b initially carry a first outer radial bearing 28, in which an eccentric ring 29 is then arranged, and radially inside of this a second inner radial bearing 30, which in turn carries a support ring 26. The support ring 26 is intended to come into contact with the crushing cone and to support it radially in a head region in order to form a gyratory crusher in this way.

### LIST OF REFERENCE SYMBOLS (PART OF THE DESCRIPTION)

1 cone crusher
2 crusher housing
4 crushing chamber
5 crushing ring
6 crushing cone
6-O upper section of the crushing cone
6-U lower section of the crushing cone
8 spherical plain bearing
9 spherical plain bearing socket
10 axle journal
12 eccentric bushing
14 drive journal
15 drive gear
16 sprocket
18 radially outer jacket surface of the eccentric bushing
20 crushing cone plain bearing
22 traverse
24a first traverse arm
24b second traverse arm
26 support ring
28 first outer radial bearing
29 eccentric ring
30 second inner radial bearing
A minimal distance between axis of rotation and central axis of the crushing cone
e eccentricity
GSS-O upper closed gap
GSS-U lower closed gap
OSS-O upper open gap
OSS-U lower open gap
H height of particle
P particle
R axis of rotation of the eccentric bushing
Z central axis of the crushing cone

1. Cone crusher (1) for comminuting lumpy feed material (material to be crushed), with
a crushing cone (6) supported on an axial bearing, inclined to the axis of rotation (R) and driven by an eccentric bushing (12), wherein the eccentric bushing (12) rotates in radial guidance around a fixed axle journal (10),
characterized in that a central axis (Z) of the crushing cone (6) is aligned skewed to the axis of rotation (R) of the eccentric bushing (12).

2. Cone crusher according to claim 1, wherein a vertical distance between the central axis (Z) of the crushing cone (6) and the axis of rotation (R) is 5% or more of the eccentricity of the eccentric bushing.

3. Cone crusher according to claim 1 or 2, wherein a phase shift (DP) between the closed gaps (GSS-O) in the upper and lower regions of the crushing chamber (4) is at least 5°, preferably at least 15° and particularly preferably at least 45°.

4. Cone crusher according to any one of the preceding claims, wherein a phase shift (DP) between a lower closed gap (GSS-U) and an upper closed gap (GSS-O) is at most 180°, preferably at most 90°.

5. Cone crusher according to any one of the preceding claims, comprising a head eccentric bushing which is axially spaced from the eccentric bushing (12) along the axis of rotation (R) and radially guides the crushing cone (6) on the axle journal (10) in the region of a minimum distance between the axis of rotation (R) and the central axis (Z). of the crushing cone (6).

6. Cone crusher according to any one of the preceding claims, comprising a balancing weight which is arranged with its center of mass out of phase with the deflection plane of the central axis (Z) of the crushing cone.

7. Cone crusher according to any one of the preceding claims, wherein the central axis (Z) of the crushing cone (6) is aligned with the axis of rotation (R) of the eccentric bushing (12) in such a way that in an upper region of the crushing chamber (4) a relative stroke of at least 3%, preferably at least 5% can be carried out.

8. Cone crusher according to any one of the preceding claims, wherein the crushing cone (6) is floatingly mounted.

9. Cone crusher according to any one of the preceding claims, comprising a head support (22) for the crushing cone (6), wherein the crushing cone (6) is freely rotating but eccentrically mounted on the head support.

10. Cone crusher according to claim 9, wherein the head support (22) comprises a first outer radial bearing (28) and a second inner radial bearing (30), wherein the second inner radial bearing (30) is eccentrically mounted radially within the first outer radial bearing (28) and the crushing cone (6) is mounted on the second inner radial bearing (28).

11. Cone crusher according to claim 9 or 10, comprising a synchronization device for synchronizing the eccentric bushing (12) with the bearing of the crushing cone (6) on the head support (22).

12. Eccentric bushing (12) for use with a cone crusher (1) according to any one of the preceding claims.

13. Eccentric bushing according to claim 11, which has a skewed arrangement of a radially inner plain bearing and a radially outer plain bearing relative to one another.

14. Method for comminuting lumpy feed material (material to be crushed) by means of a cone crusher (1) according to any one of claims 1 to 11, wherein the crushing cone (6) is driven in such a way that an upper closed gap (GSS-O) precedes a lower closed gap (GSS-U).

15. Method for comminuting lumpy feed material (material to be crushed) by means of a cone crusher (1) according to any one of claims 1 to 11, wherein the crushing cone (6) is driven in such a way that an upper closed gap (GSS-O) follows a lower closed gap (GSS-U).
